(19) United States
(12) Patent Application Publication
(10) Pub. No.: US 2026/0346665 A1
(43) Pub. Date: Nov. 5, 2026

(54) VEHICLE FLOTATION DEVICE AND METHOD

(71) Applicant: David A. Brocato, Bloomingdale, IL (US)

(72) Inventor: David A. Brocato, Bloomingdale, IL (US)

(21) Appl. No.: 19/194,454

(22) Filed: Apr. 30, 2025

(51) Int. Cl. B60F 3/00

(52) U.S. Cl. CPC B60F 3/0038

(57) ABSTRACT

A flotation device and method for protecting a vehicle during a flooding event are disclosed. An annular support structure includes a first tubular portion and a second tubular portion and the annular support structure is configurable between an undeployed state in which the first tubular portion and the second tubular portion are deflated and a deployed state in which the first tubular portion and the second tubular portion are inflated. The first tubular portion and the second tubular portion are disposed on opposite sides of the annular support structure and the first tubular portion and the second tubular portion are fluidically coupled to one another. The annular support structure is adapted to be disposed in the undeployed state between a chassis of the vehicle and the ground and to be configured in the deployed state when supplied with gas from a source of gas. The annular support structure in the deployed state is configured to support the chassis above a level of water during the flooding event.

### FIELD OF DISCLOSURE

The present subject matter relates to devices for protecting a vehicle from flood waters and more particularly, a vehicle flotation device to protect the vehicle during a flood.

### BACKGROUND

Even if a land-based vehicle is parked on dry land, a change in weather conditions, for example, a sudden storm or downpour, or a rise water levels of a stream or river proximate the vehicle may expose the vehicle to a significant amount of water. A vehicle may sustain significant damage if such water enters the interior of a chassis of the vehicle and especially if mechanical and electrical components of such vehicle are exposed to water. Such damage may include rust, mold and mildew, corrosion, and the like. Further, exposure of electrical components to water may damage the electrical system to result in the vehicle being inoperable. Sometimes the damage may not be repairable or even if the damage is repairable the costs to do so may not be feasible.

### SUMMARY

According to one aspect, a flotation device to protect a vehicle during a flooding event includes an outer annular support structure and an inner annular support structure disposed in an interior of the outer annular support structure. The inner annular support structure includes a first outer tubular portion, a second outer tubular portion, a third outer tubular portion, and a fourth outer tubular portion fluidically coupled to one another. The inner annular support structure includes a first inner tubular portion, a second inner tubular portion, a third inner tubular portion, and a further inner tubular portion fluidically coupled to one another. The outer annular support structure and the inner annular support structure are adapted to be disposed in the undeployed state between a chassis of the vehicle and the ground, the outer annular support structure and the inner annular support structure are adapted to be configured in the deployed state when supplied with gas from a source of gas, and the outer annular support structure and inner annular support structure in the deployed state are configured to support the chassis above a level of water during the flooding event.

According to another aspect, a flotation device to protect a vehicle during a flooding event includes an annular support structure and a source of gas coupled to the annular support structure. The annular support structure includes a first tubular portion and a second tubular portion. The annular support structure is configurable between an undeployed state in which the first tubular portion and the second tubular portion are deflated and a deployed state in which the first tubular portion and the second tubular portion are inflated. The first tubular portion and the second tubular portion are disposed on opposite sides of the annular support structure and the first tubular portion and the second tubular portion are fluidically coupled to one another. The annular support structure is adapted to be disposed in the undeployed state between a chassis of the vehicle and the ground and to be configured in the deployed state when supplied with gas from a source of gas. The annular support structure in the deployed state is configured to support the chassis above a level of water during the flooding event.

According to yet another aspect, a method of protecting a vehicle during a flooding event providing an annular support structure and coupling a source of gas to the annular support structure. The annular support structure includes a first tubular portion and a second tubular portion and the annular support structure is configurable between an undeployed state in which the first tubular portion and the second tubular portion are deflated and a deployed state in which the first tubular portion and the second tubular portion are inflated. The first tubular portion and the second tubular portion are disposed on opposite sides of the annular support structure and the first tubular portion and the second tubular portion are fluidically coupled to one another. The method further includes disposing the annular support structure in the undeployed state between a chassis of the vehicle and the ground and supplying gas from a source of gas to the annular support structure to configure the annular support structure in the deployed state. The annular support structure in the deployed state is configured to support the chassis above a level of water during the flooding event.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a side elevation view of a vehicle flotation device in an environment with a vehicle in accordance with the present disclosure;

FIG. 2 is a side elevation view of a side of the vehicle flotation device of FIG. 1 prior to deployment;

FIG. 3 is a side elevation view of the vehicle flotation device of FIG. 1 after deployment;

FIG. 4 is a top plan view of the vehicle flotation device of FIG. 1 in an undeployed state;

FIG. 5 is a bottom plan view of the embodiment of the vehicle flotation device of FIG. 1 in a deployed state in an environment with a vehicle;

FIG. 5A is a sectional view of a tubular portion of the vehicle flotation device of FIG. 1 taken generally along the line 5A-5A of FIG. 5;

FIG. 6 is a front elevation view of the vehicle flotation device of FIG. 1 after deployment;

FIG. 7 is a bottom plan view of another embodiment of the vehicle flotation device of FIG. 1 after deployment;

FIG. 8 is an isometric view of the vehicle flotation device of FIG. 1 disposed in a carrier device;

FIG. 9 is a magnified view of a portion labeled “FIG. 9” in FIG. 8;

FIG. 10 is an exploded view of the vehicle flotation device of FIG. 1 disposed in a carrier device;

FIG. 11 is a front elevation view of another embodiment of the vehicle flotation device of FIG. 1 in a deployed state;

FIG. 12 is a bottom plan view of the vehicle flotation device of FIG. 9 disposed in a carrier device;

FIG. 13 is a front elevation view of yet another embodiment of the vehicle flotation device of FIG. 1 in a deployed state; and

FIG. 14 is a bottom view of the vehicle flotation device of FIG. 11 in a deployed state.

### DETAILED DESCRIPTION

As disclosed herein, a vehicle flotation device may be used to protect a vehicle from water exposure due to flooding. The vehicle flotation device comprises one or more annular support structures, each formed from one or more inflatable tubular portions such as pontoons, or tubes secured together or formed integrally with one another. In some embodiments, the one or more inflatable tubular portions are fluidically coupled together so that a fluid (e.g., a gas) may pass therebetween. The vehicle flotation device may be stored in a compact folded state, for example, in a trunk of the vehicle when not in use, i.e., in an undeployed state. The vehicle flotation device may be unfolded and positioned on a portion of the ground while the tubular portions are not inflated and the vehicle may be positioned over the support structure when the flooding conditions are forecast. The tubular portions of the support structure may then be inflated to deploy the support structure(s) so that the inflated tubular portions will support the chassis of the vehicle above a level of flood waters in case flooding occurs. In some embodiments, the vehicle is positioned relative to the support structure(s) so the support structure(s) surround(s) or overlap(s) a center of gravity of the vehicle, which is typically located between the front and rear axles of a vehicle. In some cases, one end of a tether line may be secured to the vehicle flotation device or the vehicle and another end of the tether line may be secured to an immovable object such as a tree, a pole, a bollard and the like to prevent the vehicle from floating away with a water current that may be produced during a flood.

In some embodiments, the vehicle flotation device includes a carrier device having a first frame and a second frame. As described in greater detail below, the first frame is secured to an underside of the chassis of the vehicle and the support structure(s) may be disposed between the first frame and the second frame in the undeployed state. Thereafter, the first frame and the second frame may be secured together so that the support structure(s) is held therebetween. If flooding conditions are forecasted, the support structure(s) may be released from the frame to drop into position under the vehicle, and deployed as describe above. After flood waters have receded or the threat of flooding has passed, the support structure(s) may be returned to the undeployed state by deflating the tubular portions thereof and stored in the frame once again for future use.

The vehicle flotation device may include a pressurized gas cannister (or another source of gas) fluidically coupled to the support structure(s) by a valve structure or gas line to facilitate inflation of the tubular portions of the support structure(s) as necessary. In some embodiments, the gas cannister may be coupled in this manner even when the vehicle flotation device is in the undeployed state. To prevent unintended inflation of the pontoons, the gas cannister and/or the gas line may include a diverter valve that is actuated if the gas pressure in the gas line exceeds a predetermined level. When the support structure(s) is/are secured in the carrier device, the first and second frames of the carrier device prevent unintended inflation of the inflatable device. If the gas cannister is actuated while the support structure(s) is/are secured in the carrier device, force applied by the first and second frame against the tubular portions of the support structure(s) prevents inflation of such tubular portions and causes gas pressure in the gas line to increase, which in turn causes actuation of the diverter valve to release additional gas from the cannister to the ambient environment instead of flowing through the gas line into the pontoons.

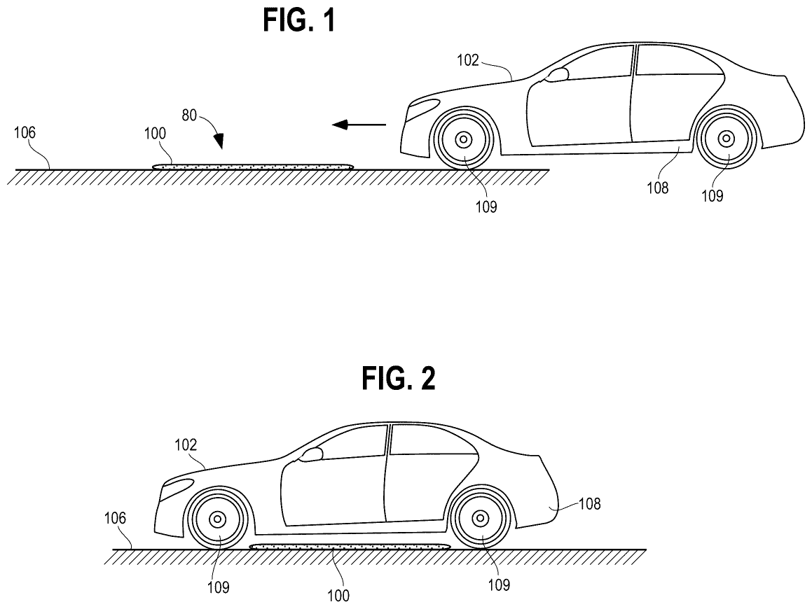

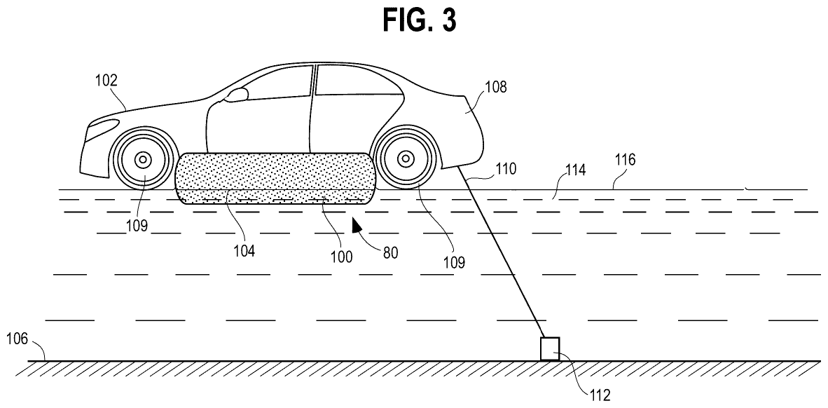

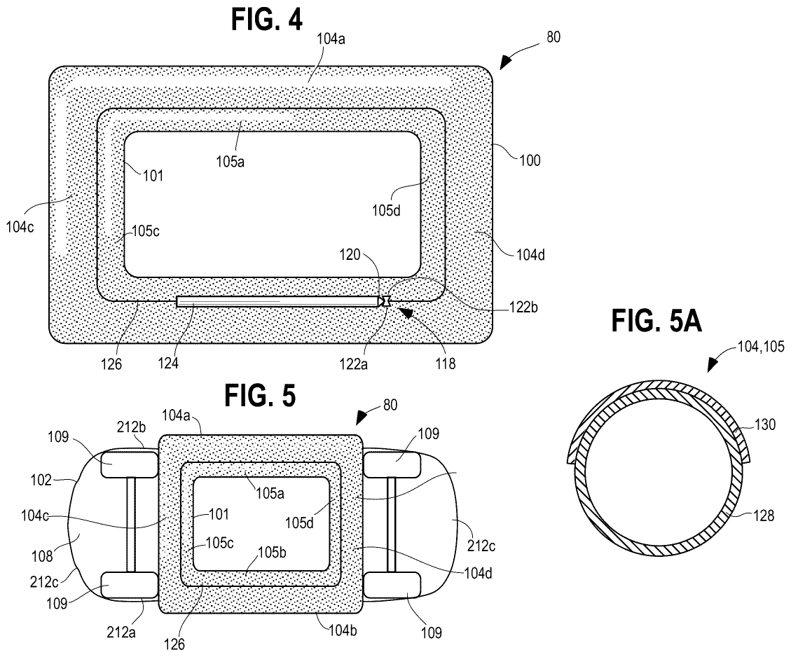

FIGS. 1-7 show a vehicle flotation device 80. In particular, FIGS. 1, 2, and 4 show the vehicle flotation device 80 in an undeployed state and FIGS. 3 and 5-7 show the vehicle flotation 80 in the deployed state. The vehicle flotation device 80 comprises an outer annular support structure 100 formed from flotation tubular portions 104 such as inflatable pontoons, flotation tubes, inflatable sections, and the like as shown in FIGS. 4 and 5 that are joined and/or fluidly coupled to one another. In some embodiments, the outer annular support structure 100 is substantially annular in shape and includes substantially linear and fluidically coupled passenger-side, driver-side, front-side, and rear-side outer tubular portion 104a, 104b, 104c, and 104d. The vehicle flotation device 80 includes an inner annular support structure 101 disposed in the interior of the outer annular support structure 100 that comprises fluidically coupled inner flotation tubular portions 105 such as inflatable pontoons, flotation tubes inflatable sections, and the like. The inner flotation tubular portion 101 is substantially annular in shape and defines a central opening of the vehicle flotation device 80. The inner flotation tubular portion 101 includes fluidly coupled, substantially linear, passenger-side, driver-side, front-side, and rear-side inner tubular portions 105a, 105b, 105c, and 105d.

In some embodiments, the passenger-side, driver-side, front-side, and rear-side outer tubular portion 104a, 104b, 104c, 104d may be formed from separate pontoons and/or tubes fluidically coupled to one another. Alternately such tubular portions 104 may be integral with one another so that the outer support structure 100 comprises a continuous annular tube. In some embodiments, the passenger-side, driver-side, front-side, and rear-side inner tubular portions 105a, 105b, 105c, 105d may be formed from separate pontoons and/or tubes fluidically coupled to one another. Alternately, such inner tubular portions 105 may be integral with one another so that the inner support structure 101 comprises a continuous annular tube.

In some embodiments, the one or more of the passenger-side, driver-side, front-side, and rear-side outer tubular portions 104 are joined with corresponding passenger-side, driver-side, front-side, and rear-side inner tubular portions 105. In some embodiments, when the passenger-side outer tubular portion 104a, the outer driver-side outer tubular portion 104b, the passenger-side inner tubular portion 105a, and inner driver-side the tubular portion 105b are inflated such portions 104a, 104b, 105a, 105b extend in directions substantially parallel to a first direction and thus all of these tubular portions 104a, 104b, 105a, 105b are substantially parallel to each other. In some embodiments, when the front outer tubular portion 104c, the rear outer tubular portion 104d, the front inner tubular portion 105c, and the rear inner tubular portion 105 are inflated, these tubular portions 104c, 104d, 105c, 105d all extend in directions substantially parallel to a second direction and thus of these tubular portions 104c, 104d, 105c, 105d are substantially parallel to each other. In some embodiments, the first direction and the second direction are substantially perpendicular directions.

The flotation device 80 includes a valve structure 118 having a valve input port 120, a first valve output port 122a, and a second valve output port 122b. The first valve output port 122a is fluidically coupled to an input port of one of the outer tubular portions 104 of the outer support structure 100 and the second valve output portion 122b is fluidically coupled to an input port of one of the inner tubular portions 105 of the inner support structure 101.

To deploy the flotation device (i.e., inflate the outer and inner tubular portions 104, 105), a pressurized gas canister 124 may be coupled to the valve input 120 and actuated to cause gas to flow from the pressurized gas canister 124 through the valve structure 118 and into the outer tubular portions 104 and the inner tubular portions 105 via the first and second valve output ports 122a, 122b respectively. The valve structure 118 may comprise a one-way valve that prevents backflow of gas from the inner and outer tubular portions 104, 105, respectively, toward the valve input. In some embodiments, the outer and inner tubular portions 104, 105 are configured so that a recessed region 126 may be formed where such tubular portions 104, 105 are joined and the canister 124 may be disposed in such recessed region 126. In some embodiments, the flotation device 80 may include a securement device (not shown) such as a tie, a hook and loop closure, a strap, and the like to maintain the canister 124 securely in the recessed region 126.

The inflatable tubular structures 104, 105 are made of a durable, lightweight, flexible, material such as an aramid fiber (e.g., poly-paraphenylene terephthalamide or Kevlar) or polychloropene (i.e., Neoprene) developed by the E.I. duPont de Nemours and Company (“DuPont”), and the like. Referring to FIG. 5A, in some embodiments, the tubular structures 104, 105 may comprise inflatable portion 128 made of a highly flexible material such as Neoprene and the like, and a protective portion 130 that surrounds at least a section of the inflatable portion 120 that is made of a highly durable material such as Kevlar and the like. In some embodiments, the protective portion 130 portion surrounds a portion of the inflatable portion 120 that is proximate or that may come in contact with a bottom of the vehicle 80 and/or the chasses 108. In other embodiments, the protective portion 140 may surround the entirety of the inflatable portion 120. The inflatable portion 128 and the protective portion 130 may be joined to one another by an adhesive, fusing, and the like. In such embodiments, the protective portion 130 separates the inflatable portion 130 from the chassis 108 to prevent inadvertent damage (e.g., puncturing) to the inflatable portion 130.

As discussed above, the gas canister 124 or another source of gas (not shown) may be coupled to the inflatable tubular portions 104, 105 via a gas input 120 to inflate the tubular portions 104, 105 and thereby deploy the vehicle flotation device 80 and the inner and outer support structures 100, 101 if flooding is forecast or otherwise expected. Although the inner and outer support structures 100, 101 are shown having four outer tubular portions 104 and four inner tubular portions 105, it should be apparent to one who has skill in the art that the outer and inner support structures 100, 101 may include more of fewer tubular portions 104.

Prior to use, the outer and inner tubular portions 104, 105 of the outer and inner support structures 100, 101 in their undeployed state may be deflated so that vehicle flotation device 80 may be folded into a compact shape and stowed, for example, in a vehicle 102 or in another location. During use, the vehicle flotation device 80 still in its undeployed state is placed on a portion of the ground 106 proximate the vehicle 102 prior to a flooding event as shown in FIG. 1. Thereafter, as shown in FIG. 2, the vehicle 102 is positioned over the deflated outer and inner support structures 100, 101 so that such structures are positioned between a chassis 108 of the vehicle 102 and the ground 106 and between and free of the front and rear wheels 109 of the vehicle 102. In some embodiments, the vehicle 102 is positioned so that one or both the outer and inner support structures 100, 101 surround or overlap a center of gravity of the vehicle 102 when deployed.

If flooding is expected, the outer and inner support structures 100, 101 may be deployed as described above to inflate the tubular portions 104, 105 and the vehicle 102 may be secured by a tether line 110 to an object 112 fixed to the ground 106. The object 112 may be, for example, a tree, a light pole, a bollard, and the like. In some cases, the vehicle flotation device 80 may be secured to the object 112 in addition to or instead of the vehicle 102.

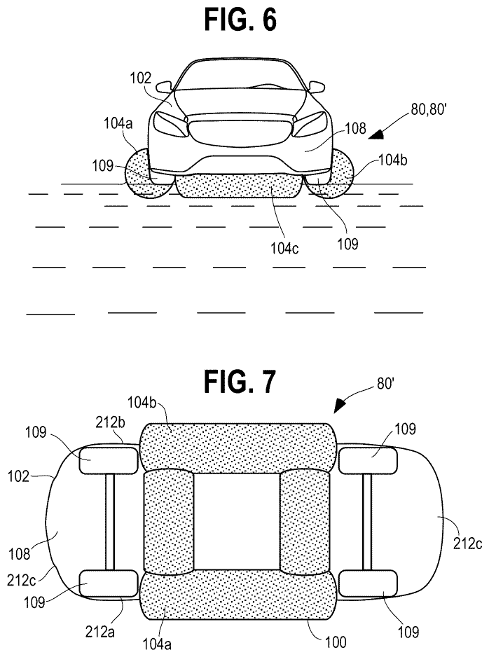

If flooding occurs, as shown in FIGS. 3 and 6, the vehicle flotation device 80 in its deployed state floats in the flood waters 114 sufficiently to support the chassis 108 of the vehicle 102 above a surface 116 of such flood waters 114 and thereby prevents the flood waters 114 from entering and damaging the vehicle 102 or components thereof. In some embodiments, the passenger-side and driver-side outer tubular portions 104a, 104b may extend outward beyond a perimeter of the chassis 108 of the vehicle when inflated and at least a portion of the exterior of the passenger-side and driver-side of the vehicle. In some embodiments, the passenger-side and driver-side outer tubular portions 104, 104b may overlap a bottom portion of a passenger-side door and the driver-side door to further prevent flood waters entering a cabin of the vehicle.

As noted above, the outer and inner support structures 104, 105 are disposed beneath the vehicle 102 to surround or overlap the center of gravity of the vehicle 102 when deployed. As should be apparent to one who has ordinary skill in the art, a position of such center of gravity may depend on the configuration, location, and weight of the components (e.g., motor, battery, etc.) of the vehicle 102 but the center of gravity is typically between the front and rear wheels 109 of vehicle 102. Having the support outer and inner support structures 104, 105 surround or overlap the center of gravity facilitates the vehicle flotation device 80 supporting the vehicle 102 when in the deployed (e.g., inflated) state and floating in the flood waters 114.

In some embodiments, the flotation device 80 that comprises both outer and inner support structures 100, 101 may be usable in cases one of the inner or outer support structures 100, 101 becomes damaged, for example, by the chassis of the vehicle 108, being punctured by debris floating in flood waters, hitting a protrusion extending from the ground, and the like. However, in some embodiments, as shown in FIGS. 6 and 7, the flotation device 80′ may include only the outer support structure 100. The floatation device 80′ operates in substantially the same manner as described in connection with the flotation device 80 described above except this flotation device only includes the outer support structure 100.

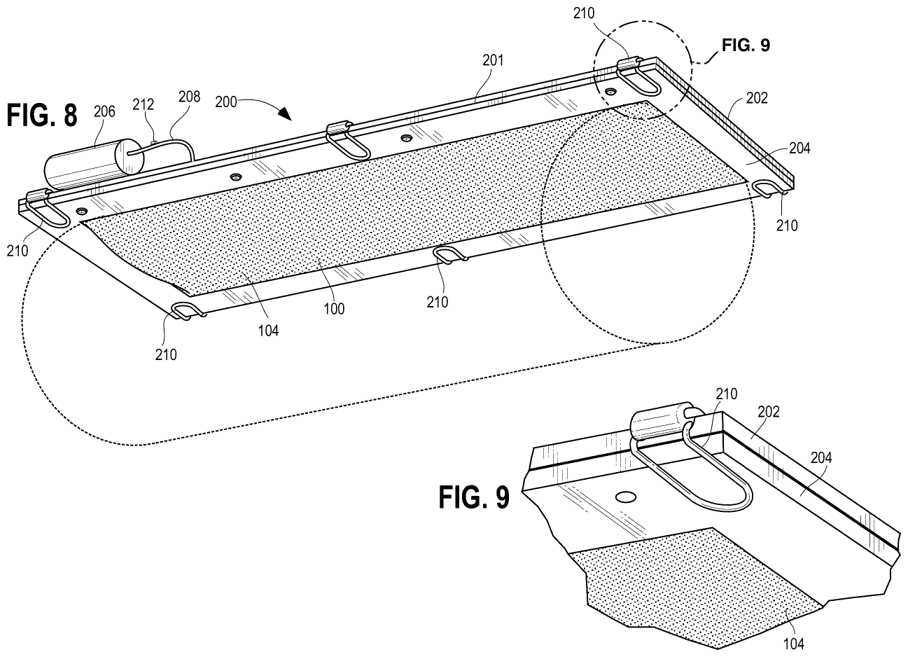

FIGS. 6-8 show an embodiment of a vehicle flotation device 200 comprising a carrier device 201 having a first frame 202 and a second frame 204. The first frame 202 is joined (e.g., by bolts, screws, and/or other fasteners) to a ground facing side of the chassis 108 of the vehicle 102. The support structure 100 may be secured to the first frame 202, and the gas cannister (or another source of gas) 206 may be fluidically coupled to the tubular portions 104 by a gas line 208. In some embodiments, the support structure 100 may be releasably secured to the first frame 202, for example, using hook and loop closures, snap closures, an adhesive, or other releasable fasteners apparent to one who has skill in the art. In other embodiments, the support structure 100 may be permanently secured to the first frame 202, for example, by one or more tethers or ropes or other connectors that allow the support structure 100 fall away from the frame 202 when the frames 202, 204 are unclamped yet remain attached to the frame 202. When the vehicle flotation device 200 is in the undeployed state, the support structure 100, i.e., the tubular portions 104 comprising the support structure 100, are sandwiched between the first frame 202 and the second frame 204, and the first frame 202 and the second frame 204 are secured to one another by one or more clamps 210. In some embodiments, the uninflated support structure 100 may be disposed between the first frame 202 and the second frame 204 in an unfolded state. In other embodiments, the uninflated support structure 100 may be folded into a compact shape and then disposed between the first frame 202 and the second frame 204.

When the vehicle flotation device 200 is in the undeployed state, the clamps 210 secure the first frame 202 and the second frame 204 to one another sufficiently to prevent unintentional inflation of the tubular portions 104 in case the flow of gas from the cannister 206 is accidentally actuated (e.g., if the vehicle 102 goes over a bump or the underside of the chassis 108 hits an obstacle). Further, a flow or diverter valve 212 is disposed at an output of the cannister 206 or along the gas line 208 to divert gas flowing from the cannister 206 to the ambient environment if the pressure within the gas line 208 exceeds a predetermined amount. As discussed above, the pressure within the gas line 208 may increase if the cannister 206 is actuated while the support structure 100 is secured between the clamped first frame 202 and the second frame 204 because clamping the first and second frames 202, 204 prevent inflation of the one or more tubular portions 104 that comprise the support structure 100 disposed therebetween.

To deploy the vehicle flotation device 200, the clamps 210 are released to allow separation of the first frame 202 from the second frame 204 so that the second frame 204 is removed from the vehicle flotation device 200 and the support structure 100 is allowed to drop and be positioned beneath the vehicle 102. Thereafter, flow of gas from the cannister 206 may be actuated to flow through the gas line 208 to inflate the tubular portions 104 and deploy the support structure 100 as described above in connection with the vehicle flotation device 100.

In some embodiments, the support structure 100 of the vehicle flotation device 200 is not secured to the first frame 202. Rather, the support structure 100 is held in place between the first frame 202 and the second frame 204 when such frames 202, 204 are secured to one another by the clamps 210. In such cases, releasing the clamps 210 allows the support structure 100 to fall to the ground, unfolded, and be positioned beneath the vehicle 102 as described above in connection with the vehicle flotation device 100. In such embodiments, the support structure 100 may be released from the first and second frames 202, 204 associated with a first vehicle 102 (i.e., the vehicle to which the first frame 202 is attached) and positioned beneath a second vehicle 102 and deployed to support the second vehicle 102 in case of flooding as described above.

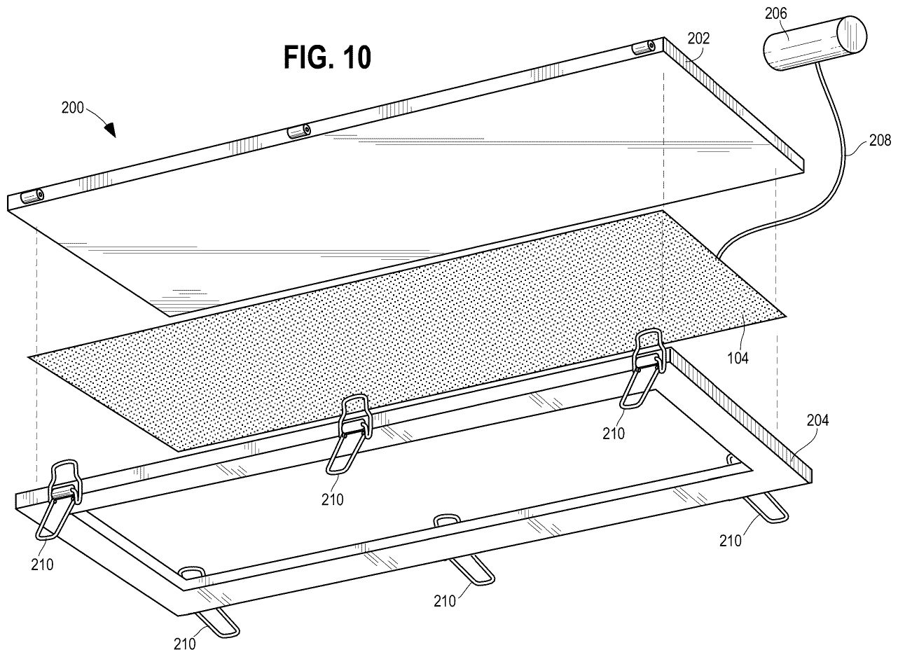

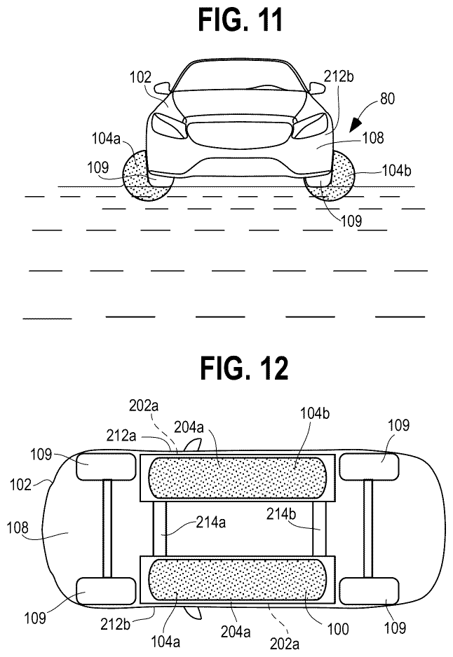

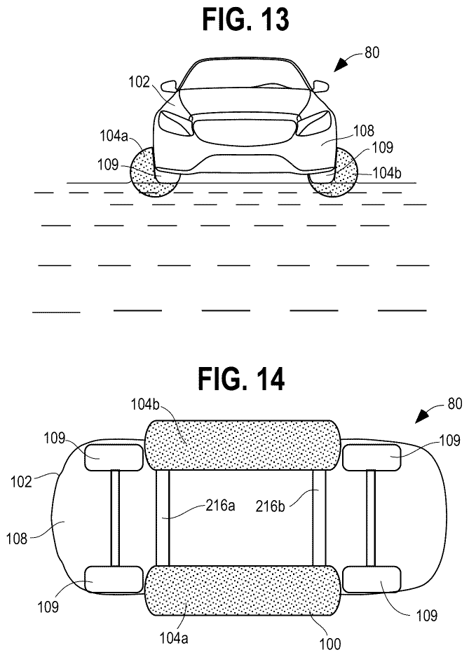

Referring to FIGS. 9-12, in some embodiments, the carrier device 201 of the vehicle flotation device 200 may include a passenger-side first frame 202a secured to the chassis 108 proximate a passenger-side 212a of the vehicle 102 and a driver-side first frame 202b secured to the chassis 108 proximate a driver-side 212 of the vehicle 102. Such embodiments may also include a driver-side second frame 204a and a driver-side second frame 204b that may be clamped to the passenger-side first frame 202a and the driver-side second frame 202b as described above. The passenger-side second frame 204a and the driver-side second frame 204b may be joined to one another by front and rear cross-members 214a, 214b so that the second frames 204a, 204b may be released from the first frames 202a, 202b as a unit. The support structure 100 may comprise a passenger-side tubular portion 104a disposed between the passenger-side first and second frames 202a, 204a and a driver-side tubular portion 104b disposed between the driver-side first and second frames 202b, 204b.

The passenger-side tubular portion 104a and the driver-side tubular portion 104b may be fluidically coupled to one or more coupling members 216. In some embodiments, the one or more coupling members 216 may be comprise additional gas lines (not shown) that facilitate flow of inflation gases between the passenger-side and driver-side tubular portions 104a, 104b. In other embodiments, the one-or more coupling members 216 may also be tubular portions similar to the passenger-side and driver-side tubular portions 104a, 104b. The coupling members 216 facilitate inflation of the passenger-side tubular portion 104a and the driver-side tubular portion 104b using a single cannister 206 that is fluidically coupled by the gas line 208 to one such tubular portion 104a, 104b or one of the coupling members 216. In some embodiments, the front and rear cross-members 214a, 214b may be positioned so that the one or more coupling members 216 are secured between the chassis 108 and the cross-members 214a, 214b and thereby protected from damage when the vehicle flotation device 200 is not deployed.

In some embodiments, the passenger-side tubular portion 104a and the driver-side tubular portion 104b are substantially linear and parallel when deflated and the support structure 100 is positioned beneath the vehicle 102 in preparation for deployment. In some embodiments, the passenger-side tubular portion 104a and the driver-side tubular portion 104b are substantially cylindrical and have substantially parallel axes when inflated. Further, in some embodiments, a front-side tubular portion 104c disposed proximate a front 212c of the vehicle 102 and a driver-side tubular portion 104d disposed proximate a rear 212d of the vehicle are also substantially parallel when deflated and positioned for deployment, and/or substantially cylindrical and have substantially parallel axes when inflated. In some embodiments, the front-side tubular portion 104c and the rear-side tubular portion 104d are substantially perpendicular to one or both of the passenger-side tubular portion 104a and the driver-side tubular portion 104b.

In some of the embodiments in which the support structure 100 includes front-side and rear-side coupling members 216a, 216b, the coupling members 216a, 216b are substantially parallel and/or linear when the support structure 100 is coupled to the vehicle 102 by the frames 202 and 204.

While particular embodiments of the vehicle flotation device have been illustrated and described, it would be apparent to those skilled in the art that various other changes and modifications can be made and are intended to fall within the spirit and scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

I claim:

1. A flotation device to protect a vehicle during a flooding event, comprising:
an outer annular support structure comprising a first outer tubular portion, a second outer tubular portion, a third outer tubular portion, and a fourth outer tubular portion fluidically coupled to one another; and
an inner annular support structure disposed in an interior of the outer support structure, wherein the inner annular support structure comprises a first inner tubular portion, a second inner tubular portion, a third inner tubular portion, and a fourth inner tubular portion fluidically coupled to one another;
wherein the outer annular support structure and the inner annular support structure are adapted to be disposed in the undeployed state between a chassis of the vehicle and the ground, the outer annular support structure and the inner annular support structure are adapted to be configured in the deployed state when supplied with gas from a source of gas, and the outer annular support structure and inner annular support structure in the deployed state are configured to support the chassis above a level of water during the flooding event.

2. The flotation device of claim 1, wherein the first outer tubular portion, the second outer tubular portion, the first inner tubular portion and the second inner tubular portion are parallel to one another and the third outer tubular portion, the fourth outer tubular portion, the third inner tubular portion, and the fourth inner tubular portion area parallel to one another.

3. The flotation device of claim 1, wherein the first outer tubular portion and the first inner tubular portion are joined together.

4. The flotation device of claim 1, further including a valve device having a input port, a first output port fluidically coupled to the outer support structure, and a second output port fluidically coupled to the inner support structure, wherein the input port is adapted to deliver gas from a source of gas to the first output port and the second output port and thereby cause inflation of the outer support structure and the inner support structure, respectively.

5. The flotation device of claim 1, wherein the first tubular portion comprises an inflatable portion comprising a first material and a protective covering made of a second material, wherein the protective covering covers only a portion of the first material.

6. The flotation device of claim 5, wherein the first material is Neoprene and the second material is Kevlar.

7. A flotation device to protect a vehicle during a flooding event, comprising:
an annular support structure comprising a first tubular portion and a second tubular portion, wherein the annular support structure is configurable between an undeployed state in which the first tubular portion and the second tubular portion are deflated and a deployed state in which the first tubular portion and the second tubular portion are inflated, the first tubular portion and the second tubular portion are disposed on opposite sides of the annular support structure, and the first tubular portion and the second tubular portion are fluidically coupled to one another;
wherein the annular support structure is adapted to be disposed in the undeployed state between a chassis of the vehicle and the ground, the annular support structure is adapted to be configured in the deployed state when supplied with gas from a source of gas, and the annular support structure in the deployed state is configured to support the chassis above a level of water during the flooding event.

8. The flotation device of claim 7, wherein the annular support structure further comprises a third tubular portion and a fourth tubular portion, wherein the third tubular portion and the fourth tubular portion are disposed opposite one another, and the third tubular portion and the fourth tubular portion are fluidically coupled to one another and to the first tubular portion and the second tubular portion.

9. The flotation device of claim 8, wherein the support structure in the undeployed state is adapted to be positioned intermediate front wheels and rear wheels of the vehicle.

10. The flotation device of claim 7, wherein the support structure is folded for storage when in the undeployed state.

11. The flotation device of claim 7, further comprising a first frame and a second frame, wherein the first frame is secured to the chassis of the vehicle between the chassis and the ground, the second frame is secured to the first frame, and the support structure in the undeployed state is disposed intermediate the first frame and the second frame.

12. The flotation device of claim 11, further comprising a gas line that fluidically couples the source of gas and the support structure and a valve disposed between the source of gas and the support structure, wherein the valve is configured to release gas to the ambient environment when pressure within the gas line exceeds a predetermined amount.

13. The flotation device of claim 11, wherein the first frame comprises a first passenger-side frame and the second frame comprises a second passenger-side frame, further including a first driver-side frame and a second driver-side frame, wherein the first driver-side frame is secured to the chassis of the vehicle, the second driver-side frame is secured to the first driver-side frame, and the first tubular portion is disposed intermediate the first passenger-side frame and the second passenger-side frame and the second tubular portion is disposed intermediate the first driver-side frame and the second driver-side frame.

14. A method of protecting a vehicle during a flooding event, comprising:
providing an annular support structure comprising a first tubular portion and a second tubular portion, wherein the annular support structure is configurable between an undeployed state in which the first tubular portion and the second tubular portion are deflated and a deployed state in which the first tubular portion and the second tubular portion are inflated, the first tubular portion and the second tubular portion are disposed on opposite sides of the annular support structure, and the first tubular portion and the second tubular portion are fluidically coupled to one another;
disposing the annular support structure in the undeployed state between a chassis of the vehicle and the ground; and
supplying gas from a source of gas to the annular support structure to configure the annular in the deployed state, wherein the annular support structure in the deployed state is configured to support the chassis above a level of water during the flooding event.

15. The method of claim 14, wherein the annular support structure further comprises a third tubular portion and a fourth tubular portion, wherein the third tubular portion and the fourth tubular portion are disposed opposite one another, and the third tubular portion and the fourth tubular portion are fluidically coupled to one another and to the first tubular portion and the second tubular portion.

16. The method of claim 15, further including positioning the support structure in the undeployed state intermediate front wheels and rear wheels of the vehicle.

17. The method of claim 14, further including folding the support structure for storage when in the undeployed state.

18. The method of claim 14, further including securing a first frame to the chassis of the vehicle between the chassis and the ground, securing a second frame to the first frame, and disposing the support structure in the undeployed state intermediate the first frame and the second frame.

19. The method of claim 18, further including fluidically coupling the source of gas and the support structure by a gas line, disposing a valve between the source of gas and the support structure, and configuring the valve to release gas to the ambient environment when the pressure within the gas line exceeds a predetermined amount.

20. The method of claim 15, wherein the first frame comprises a first passenger-side frame and the second frame comprises a second passenger-side frame, further securing a first driver-side frame to the chassis of the vehicle, securing a second driver-side frame to the first driver-side frame, and disposing the first tubular portion intermediate the first passenger-side frame and the second passenger-side frame and disposing the second tubular portion intermediate the first driver-side frame and the second driver-side frame.
